(19) United States
(12) Patent Application Publication
(10) Pub. No.: US 2019/0080423 A1
(43) Pub. Date: Mar. 14, 2019

(54) MONITORING SYSTEM, UNAUTHORIZED USE DETERMINATION DEVICE, METHOD, AND PROGRAM

(71) Applicant: NEC Corporation, Tokyo (JP)

(72) Inventor: Nao TSUMAGARI, Tokyo (JP)

(73) Assignee: NEC Corporation, Tokyo (JP)

(21) Appl. No.: 16/088,329

(22) PCT Filed: Mar. 28, 2016
(86) PCT No.: PCT/JP2016/001793

§ 371 Date: Sep. 25, 2018

(51) Int. Cl. G06Q 50/06; B67D 7/08

(52) U.S. Cl. CPC G06Q 50/06; B67D 7/08

(57) ABSTRACT

A monitoring system includes: an acquiring unit 601 which acquires actual operation data including a value indicative of an output amount, which is an observable amount correlated to the consumption of a fuel of target equipment and which is an observable amount per measurement time unit in at least an assessment period, and billing data including a value indicative of a purchase amount, which is the amount of a purchased fuel to be supplied to the target equipment during the assessment period; a determining unit 602 that determines the occurrence of an unauthorized use on the basis of the output amount per measurement time unit in the assessment period of the target equipment indicated by the actual operation data and the purchase amount of a fuel in the assessment period of the target equipment indicated by the billing data; and an output unit 603 that outputs a determination result.

### TECHNICAL FIELD

The present invention relates to a monitoring system that monitors for an unauthorized use of a fuel, an unauthorized use determination device, a monitoring method, and a monitoring program.

### BACKGROUND ART

In a developing country, there are areas where electricity infrastructure is still in its infancy or areas where power supply cannot keep up with demand, frequently resulting in power failures. In such areas, diesel generators are used to provide electric power when power failures occur.

In particular, there is a cellular phone service industry as an industry that uses many diesel generators. This is because, in order to provide a full-time cellular phone service 24 hours a day and 365 days a year with no interruption, it is required to stably supply electric power to each base station (more specifically, various types of equipment necessary for implementing the function of each base station) in various areas.

Further, depending on the country, there are cases where a company that manages communication equipment and provides user services (hereinafter referred to as “the carrier company”) is separated from a company that manages a steel tower of a base station, the land thereof and the supply of electric power to various types of equipment installed in the land (hereinafter referred to as “the tower company”). In such a case of division of work, the carrier company is charged with the expenses incurred by the tower company to manage the steel tower, the land and to operate an electric power business (hereinafter referred to as “the management cost”). There are cases where the management expenses are fixed. The tower company hires a superintendent for each station to have the superintendent carry out the maintenance of a steel tower, a land, and various types of installed equipment. The superintendent of a station procures a diesel fuel and supplies the diesel fuel to a tank connected to a diesel generator placed in the station, as part of the foregoing maintenance.

At this time, the cost of the fuel procured by the superintendent is charged to the tower company. The tower company charges the management cost to the carrier company on the basis of the cost of the fuel billed by the superintendent, the expenses spent on the steel tower, the land, and the operation of various types of equipment installed in the land.

For example, Patent Literature 1 describes a technology for determining the relationship between the consumption and the supply of a fuel. According to the technology described in Patent Literature 1, the amount of a used fuel based on actual refueling to machines, such as construction machines, which are operated on the fuel and the amount of a consumed fuel based on the fuel efficiency and the record of actual operation of the machines are calculated, and the calculated results are compared to check whether the supplied fuel has been properly used for operating the machines.

### CITATION LIST

### Patent Literature

PTL 1: Japanese Patent Application Laid-Open No. 2003-120405

### SUMMARY OF INVENTION

### Technical Problem

There has been a problem in that, in the environment wherein the supply of a fuel to equipment is performed by manpower, a company charged with fuel expenses does not have any means for detecting an unauthorized use of a fuel if a superintendent fraudulently uses the fuel with a malicious intent. Examples of such unauthorized use include a case where a superintendent steals a part of a purchased fuel for his or her personal use, i.e., a case where the superintendent does not put all of a purchased fuel into a tank or the superintendent adds water into the tank to conceal the stolen amount.

The technology described in Patent Literature 1 is intended mainly for use with construction machines. Therefore, a method based on the amount remaining in a tank and a method in which the fuel economy of a machine is calculated in advance and the consumption amount is estimated from the operating time of the machine are described as the examples of the method for calculating a fuel consumption amount. However, with such simple methods, it is difficult to detect, for example, the malicious unauthorized use of a fuel that should be supplied to a generator. In other words, a fuel consumption amount based on operating conditions cannot be accurately determined simply by using the pre-calculated operating time of a construction machine and the fuel economy (more specifically, the unit travel distance and the fuel consumption rate per unit time). Thus, the simple comparison of the consumption amount and the use amount described above may overlook unauthorized use, especially the malicious unauthorized use, in which a fuel is used by thinning the fuel by, for example, adding water to a tank.

In view of the background described above, an object of the present invention is to provide a monitoring system, an unauthorized use determination device, a monitoring method, and a monitoring program that make it possible to monitor the malicious unauthorized use of a fuel by a superintendent even in an environment in which a fuel is supplied to equipment by manpower.

### Solution to Problem

A monitoring system in accordance with the present invention includes: an acquiring unit which acquires actual operation data including a value indicative of an output amount, which is an observable amount correlated to the consumption of a fuel of target equipment and which is an observable amount per measurement time unit in at least an assessment period, and billing data including a value indicative of a purchase amount, which is the amount of a purchased fuel to be supplied to the target equipment during the assessment period; a determining unit which determines the occurrence of an unauthorized use on the basis of the output amount per measurement time unit in the assessment period of the target equipment indicated by the actual operation data and the purchase amount of a fuel in the assessment period of the target equipment indicated by the billing data; and an output unit which outputs a determination result.

An unauthorized use determination device in accordance with the present invention includes: an acquiring unit which acquires actual operation data including a value indicative of an output amount, which is an observable amount correlated to the consumption of a fuel of target equipment and which is an observable amount per measurement time unit in at least an assessment period, and billing data including a value indicative of a purchase amount, which is the amount of a purchased fuel to be supplied to the target equipment during the assessment period; a determining unit which determines the occurrence of an unauthorized use on the basis of the output amount per measurement time unit in the assessment period of the target equipment indicated by the actual operation data and the purchase amount of a fuel in the assessment period of the target equipment indicated by the billing data; and an output unit which outputs a determination result.

A monitoring method by an information processing device in accordance with the present invention includes: acquiring actual operation data including a value indicative of an output amount, which is an observable amount correlated to the consumption of a fuel of target equipment and which is an observable amount per measurement time unit in at least an assessment period, and billing data including a value indicative of a purchase amount, which is the amount of a purchased fuel to be supplied to the target equipment during the assessment period; determining the occurrence of an unauthorized use on the basis of the output amount per measurement time unit in the assessment period of the target equipment indicated by the actual operation data and the purchase amount of a fuel in the assessment period of the target equipment indicated by the billing data; and outputting a determination result.

A monitoring program in accordance with the present invention is characterized by causing a computer to perform: processing of acquiring actual operation data including a value indicative of an output amount, which is an observable amount correlated to the consumption of a fuel of target equipment and which is an observable amount per measurement time unit in at least an assessment period, and billing data including a value indicative of a purchase amount, which is the amount of a purchased fuel to be supplied to the target equipment during the assessment period; processing of determining the occurrence of an unauthorized use on the basis of the output amount per measurement time unit in the assessment period of the target equipment indicated by the actual operation data and the purchase amount of a fuel in the assessment period of the target equipment indicated by the billing data; and processing of outputting a determination result.

### Advantageous Effects of Invention

The present invention makes it possible to monitor the malicious, unauthorized use of a fuel by a superintendent even in an environment in which a fuel is supplied to equipment by manpower.

### BRIEF DESCRIPTION OF DRAWINGS

FIG. 1 is a block diagram illustrating an example of a monitoring system according to a first embodiment;

FIG. 2 is a block diagram illustrating a configuration example of an unauthorized use determining unit 3;

FIG. 3 is an explanatory diagram illustrating an example of measurement time unit and assessment time unit;

FIG. 4 is a flowchart illustrating an operation example of the unauthorized use determination device 3;

FIG. 5 is an explanatory diagram illustrating an example of actual operation data D1;

FIG. 6 is an explanatory diagram illustrating another example of an unauthorized use determination method;

FIG. 7 is a block diagram illustrating another example of the monitoring system according to the first embodiment;

FIG. 8 is a block diagram illustrating yet another example of the monitoring system according to the first embodiment;

FIG. 9 is a block diagram illustrating an example of the monitoring system according to a second embodiment;

FIG. 10 is a schematic block diagram illustrating a configuration example of a computer related to the embodiments of the present invention;

FIG. 11 is a block diagram illustrating the outline of the monitoring system in accordance with the present invention; and

FIG. 12 is a block diagram illustrating another example of the monitoring system in accordance with the present invention.

### DESCRIPTION OF EMBODIMENTS

### First Embodiment

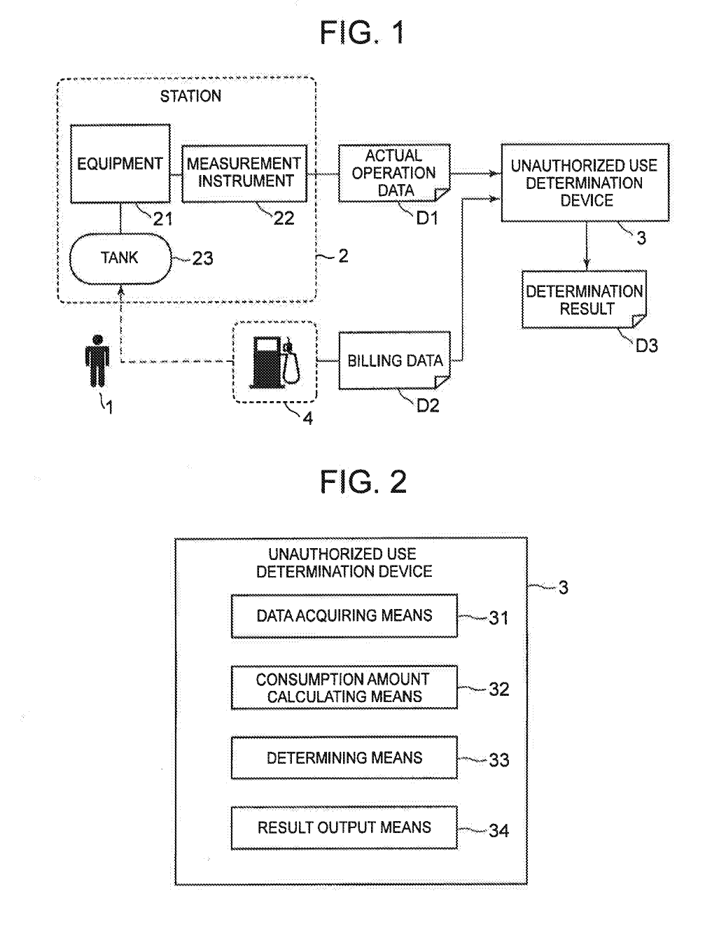

The following will describe the embodiments of the present invention with reference to the accompanying drawings. FIG. 1 is a block diagram illustrating an example of the monitoring system according to a first embodiment of the present invention. The monitoring system illustrated in FIG. 1 includes equipment 21, a measurement instrument 22, and an unauthorized use determination device 3.

The equipment 21 and the measurement instrument 22 are installed in a station 2. Further, the measurement instrument 22 and the unauthorized use determination device 3 are connected through a network.

Referring to FIG. 1, the equipment 21 is a generator or the like that operates using a fuel. The equipment 21 operates using a fuel supplied to a tank 23 connected to the equipment 21.

Further, reference numeral 1 denotes a superintendent who supplies a fuel to the tank 23. Further, reference numeral 4 denotes a gas station serving as an issuer of billing data D2, which will be discussed later.

The following will describe the present invention by using, as an example, the case where the equipment 21 is a generator. In the present invention, however, the equipment 21 is not limited to a generator, and may be any others, such as equipment, devices, vehicles and vessels insofar as they operate on a fuel and have an observable amount correlated to the consumption amount of a fuel.

The measurement instrument 22 measures a predetermined physical quantity that changes with the consumption of a fuel of the equipment 21 to which the measurement instrument 22 is connected. In this case, the physical quantity measured by the measurement instrument 22 is an observable amount that can be observed by the measurement instrument 22 provided outside the equipment 21 and is an amount correlated to the consumption of the fuel in the equipment 21 to which the measurement instrument 22 is connected. The observable amount that can be observed by the measurement instrument 22 includes an amount that can be identified by the measurement instrument 22 from a value output from the equipment 21, in addition to an amount that can be directly measured by the measurement instrument 22.

The physical quantity measured by the measurement instrument 22 is, for example, the amount of generated power if the equipment 21 is a generator, a travel distance if the equipment 21 is a vehicle, a calorific value or an endothermic amount if the equipment 21 is a heating device or a cooling device, or a compression amount if the equipment 21 is a hydraulic system. The measurement instrument 22 measures such a physical quantity (hereinafter referred to simply as “the output amount”) in a predetermined time unit (e.g. at 5-minute intervals). Hereinafter, the period during which the measurement instrument 22 measures the output amount will be referred to as the measurement period and the time unit thereof (the length of the measurement period) will be referred to as the measurement time unit in some cases. The measurement time unit may be set according to the tendency of a change in the physical quantity. Preferably, however, the measurement time unit is set to be a time unit that is shorter than one day (e.g. 3 hours, 1 hour, 30 minutes or 5 minutes) in order to improve accuracy. The measurement instrument 22 may have, for example, a function for monitoring a binary status, such as ON/OFF, in order to determine the operating time. The measurement instrument 22 has an additional function for measuring a physical quantity indicative of a continuous value, which is any one of the foregoing exemplary values continuously changing.

The measurement instrument 22 outputs actual operation data D1 which includes a value indicating the output amount per measurement time unit obtained by measurement and the information on the measurement time (e.g. measurement start time) to the unauthorized use determination device 3. The actual operation data D1 may additionally include the information for identifying the equipment 21 or the information for identifying the station 2.

Further, FIG. 2 is a block diagram illustrating a configuration example of the unauthorized use determination device 3. In the example illustrated in FIG. 2, the unauthorized use determination device 3 includes a data acquiring means 31, a consumption amount calculating means 32, a determining means 33, and a result output means 34.

The data acquiring means 31 acquires (inputs) the actual operation data D1 of the equipment 21 from the measurement instrument 22. Further, the data acquiring means 31 acquires the billing data D2 which includes a value indicating a purchase amount, which is the amount of a purchased fuel to be supplied to the equipment 21. The data acquiring means 31 may retain the acquired data as a history.

The consumption amount calculating means 32 calculates the consumption amount based on a record of actual operation of the equipment 21 in a predetermined period according to the value indicating the output amount per measurement time unit and the information on the measurement time included in the actual operation data D1. In this case, the length of the foregoing predetermined period is to be larger than the measurement time unit. Hereinafter, the period during which the consumption amount calculating means 32 determines the consumption amount will be referred to as the assessment period and the length thereof will be referred to as the assessment time unit in some cases. The consumption amount calculating means 32 may, for example, determine the consumption amount for each month. In this case, the assessment time unit will be one month. The assessment time unit is preferably a length that includes one or more fuel supply operations in the period.

The determining means 33 determines the occurrence of an unauthorized use of a fuel by comparing the consumption amount in the assessment period of the fuel of the equipment 21 calculated by the consumption amount calculating means 32 with the purchase amount in the assessment period of the fuel of the equipment 21 identified on the basis of the billing data D2. The determining means 33 may determine that an unauthorized use of the fuel has occurred if, for example, the difference between the consumption amount and the purchase amount deviates from an error range, i.e. a predetermined threshold value or more. In this case, the determining means 33 may establish the foregoing error range or the predetermined threshold value on the basis of a time lag between the purchase and the actual use of the fuel or the average amount of the fuel remaining in the tank at the time of the purchase.

If the determining means 33 determines that an unauthorized use has occurred, then the result output means 34 issues a notification or an alarm by, for example, outputting a determination result D3. The determination result D3 may include, for example, the information on the consumption amount, the purchase amount and/or the difference therebetween used for the determination of the unauthorized use and the information of the assessment period in addition to the information for identifying the equipment 21 determined to have been involved in the unauthorized use and the information for identifying the station 2 where the equipment 21 is installed.

A more detailed description will now be given of the method for calculating the consumption amount in the assessment period by the consumption amount calculating means 32. In the following description, the measurement time unit will be 5 minutes, the assessment time unit will be 30 days, and the output amount will be a total amount of generated power [Wh] in the measurement period.

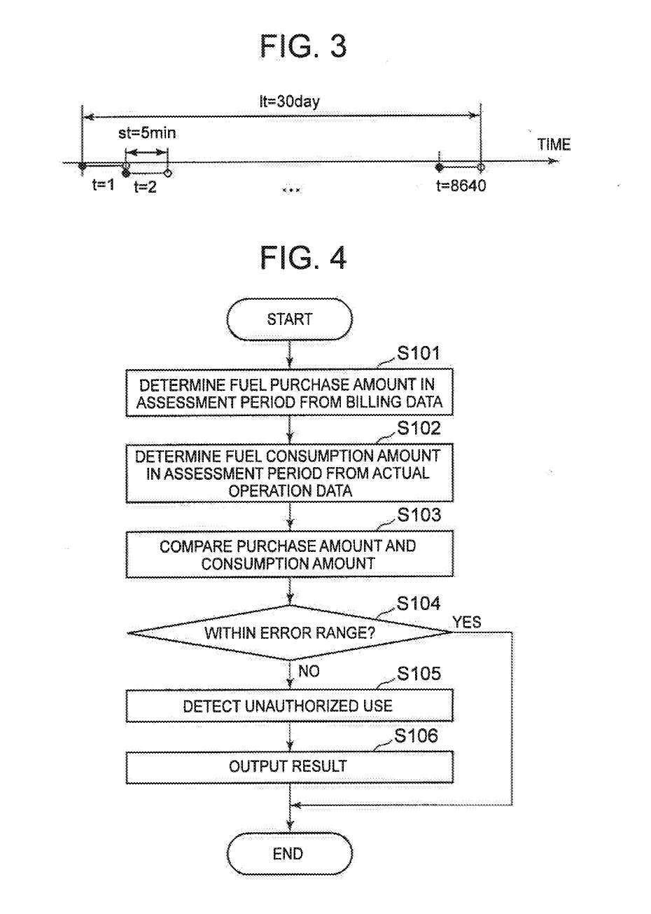

FIG. 3 is an explanatory diagram illustrating the measurement time unit and the assessment time unit on a time axis in the foregoing example. As illustrated in FIG. 3, the assessment time unit includes 8,640 measurement time units in the foregoing example. In the following description, a variable 1t [h] denoting the assessment time unit and a variable st [h] denoting the measurement time unit will be introduced for the sake of explanation. In the present example, 1t=720 [h] and st= 1/12 [h]. A variable t=1, 2, . . . , 8640 for identifying the measurement time units included in a given assessment period will be introduced. Further, a variable outs [Wh] denoting the output amount measured during each measurement time will be introduced. For example, if the assessment period for which the purchase amount of a fuel is to be determined is a period of time from 00:00 on Jan. 1, 2016 to 24:00 on Jan. 30, 2016, then the measurement period corresponding to t=1 will be the period from 00:00 on Jan. 1, 2016 to 00:05 on Jan. 1, 2016. Further, in this case, out₁ will be the total generated power [Wh] in the measurement period corresponding to t=1.

The consumption amount calculating means 32 may alternatively determine the consumption amount according to, for example, the following method. First, the consumption amount calculating means 32 determines, for each t, an average output out_aveₜ [W] in the measurement period according to expression (1) given below.

out_aveₜ [W]=outₜ[Wh]/st[h] (1)

Subsequently, based on the determined out_aver, a fuel consumption rate b [L/W·h] relative to the amount of generated power of the equipment 21 is selected. In this case, the fuel consumption rate is the amount of a fuel required to generate power of 1 W per unit time h. For example, it is known that the efficiency of a generator usually increases as the output amount increases. Hence, for example, the equipment 21 or equipment 21 having substantially the same conditions as those of the equipment 21 is used to obtain two or more different fuel consumption rates b relative to the amount of generated power in advance, and the obtained fuel consumption rates b are retained in the form of a graph or a table. The consumption amount calculating means 32 may select the fuel consumption rate b relative to the amount of generated power that is closest to the out_aveₜ determined from actual operation data.

Then, using the selected fuel consumption rate b and the total amount of generated power, which is the output amount in a target measurement period that is the period matching a target measurement time unit, a fuel consumption amount Bₜ[L] of a fuel in the target measurement period may be determined according to expression (2) given below.

Consumption amount Bₜ [L]=outₜ [Wh]×b[L/W·h] (2)

Lastly, the consumption amount calculating means 32 adds up the consumption amount in each measurement period to determine the consumption amount of the fuel in the assessment period.

As described above, the average output is calculated on the basis of the output amounts, which are the actually measured values on the equipment 21 indicated by the actual operation data in each measurement period included in the assessment period, and the fuel consumption rate of the equipment 21 based on the average output is selected so as to determine the consumption amount of the fuel. Then, the determined fuel consumption amount in each measurement period is added up to determine the fuel consumption amount in the assessment period. This method makes it possible to improve the accuracy of calculation, as compared with a method in which the consumption amount is calculated using a fuel economy given as a fixed value.

The consumption amount calculating means 32 may alternatively select the fuel consumption rate according to the length of an output duration time, such as continuous operation time, other than an average output. Further, if the fuel consumption rate differs depending on the characteristics or operating conditions of the equipment 21, such as the years of service, a model number or a fuel used, then it is preferable to acquire the information of the characteristics and operating conditions so as to select a fuel consumption rate that is best suited for actual operating conditions. As the method for calculating the consumption amount in the present embodiment, a different method may be used insofar as the method uses the output amount per measurement time unit, which is a time unit smaller than the assessment time unit, in the assessment period, and one fuel consumption amount selected on the basis of the output amount or an amount calculated using the output amount from among at least two or more different fuel consumption rates as the net fuel consumption rate per measurement time unit.

For example, if the power system at the station 2 is a power system provided with storage batteries or the like in addition to the equipment 21, which is a generator, then the output amount of the equipment 21 may fluctuate, mainly depending on whether the storage batteries or the like are charged. In a case like this where the output amount during an operation is not constant, the calculation method described above is especially effective. In this case, regarding the fuel consumption rate of the equipment 21, the unauthorized use determination device 3 preferably holds at least two fuel consumption rates, namely, the fuel consumption rate relative to a first power amount, which is a power amount required for operating at least the station 2 and the fuel consumption rate relative to a second power amount obtained by adding a power amount required for charging the storage batteries to the first power amount. Further, setting the measurement period to be shorter enables the accuracy of calculation to be further improved.

Further, regarding the purchase amount of a fuel, for example, the purchase amount of the fuel may be directly defined as the purchase amount in a period from a previous purchase to a current purchase, or if the fuel is purchased a plurality of times in an assessment period, then the amounts of the fuel purchased a plurality of times may be added up to determine the purchase amount of the fuel in the assessment period. Alternatively, the consumption amount of the fuel may be determined as described below. For example, if the amount remaining in the tank can be acquired by a sensor or the like, then the consumption amount of the fuel may be determined on the basis of the change in the amount remaining in the tank during the assessment period. In this case, the amount remaining in the tank per the measurement time unit will be the output amount.

The operation of the present embodiment will now be described with reference to FIG. 4. FIG. 4 is a flowchart illustrating an operation example of the unauthorized use determination device 3 of the present embodiment. In the example illustrated in FIG. 4, it is assumed that the actual operation data D1 including at least the value indicating the output amount per measurement time unit in the assessment period and the billing data D2 including at least the purchase amount of a fuel corresponding to the amount of the fuel supplied to the equipment 21 during the assessment period have already been acquired by the data acquiring means 31 of the unauthorized use determination device 3. Further, the unauthorized use determination device 3 retains the fuel consumption rate, which is the fuel consumption amount per unit time or unit output relative to a net output (an electric output [W] in the present example) measured using the equipment 21 of the station 2 in advance, the fuel consumption rate having been converted into liters.

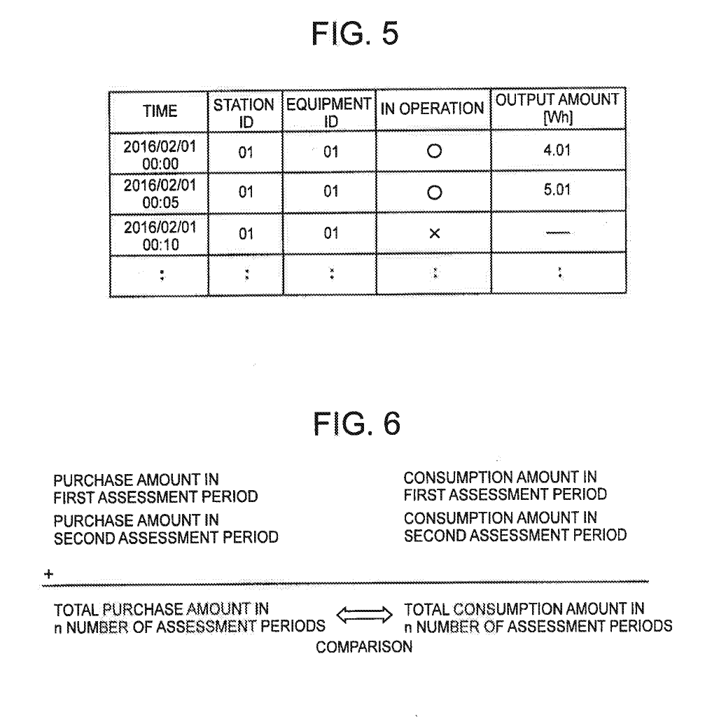

FIG. 5 is an explanatory diagram illustrating an example of the actual operation data D1 acquired by the data acquiring means 31. As illustrated in FIG. 5, the actual operation data D1 may be information that includes time information indicating a measurement start time, a station ID as the information for identifying the station 2, an equipment ID as the information for identifying the equipment 21, a flag indicating operation/non-operation, and an output amount. The flag indicating operation/non-operation may be omitted. In this case, the output amount in a non-operation period will be zero.

In such a state, first, the data acquiring means 31 determines the purchase amount of a fuel of the equipment 21 in the assessment period on the basis of the billing data D2 (step S101).

Subsequently, the consumption amount calculating means 32 determines the consumption amount of the fuel of the equipment 21 in the assessment period on the basis of the actual operation data D1 and the fuel consumption rate (step S102).

Subsequently, the determining means 33 compares the purchase amount determined in step S101 with the consumption amount determined in step S102 (step S103).

If the result of comparison indicates that the difference between the purchase amount and the consumption amount falls within an error range, i.e. a predetermined threshold value or less (Yes in step S104), then the determining means 33 determines that there is no unauthorized use and terminates the processing. Meanwhile, if the difference between the purchase amount and the consumption amount exceeds the error range, i.e. exceeds the predetermined threshold (No in step S104), then the determining means 33 detects an unauthorized use (step S105).

In response to the detection of the unauthorized use, the result output means 34 outputs the result (step S106).

As described above, the present embodiment makes it possible to accurately determine the consumption amount of a fuel of the equipment 21 without the need for manpower, so that an unauthorized use of the fuel by a superintendent with a malicious intent can be detected by comparing the determined consumption amount with a purchase amount determined from a claimed expense. Further, having such a system also makes it possible to provide effect for deterring the unauthorized use by a superintendent.

In the foregoing example, the determining means 33 has determined the occurrence of an unauthorized use by one comparison between the purchase amount and the consumption amount in a given assessment period. Alternatively, the determining means 33 may, for example, determine the occurrence of an unauthorized use by determining the difference between a purchase amount and a consumption amount in a long period in addition to the determination based on the difference in one assessment period. The determining means 33 may, for example, retain the history of data (e.g. the consumption amount, the purchase amount and the difference therebetween) calculated in a predetermined number of assessment periods in the past, and may determine the occurrence of an unauthorized use on the basis of the differences in the predetermined number of assessment periods in the past, as illustrated in FIG. 6. At this time, the predetermined number of assessment periods in the past used for the determination may be a continuous period, such as six consecutive months from January to June, or an inconsecutive period, such as August every year. Further, for example, the determining means 33, which carries out the determination of the difference for each assessment period, may determine that there is an unauthorized use if the difference continuously or cumulatively exceeds an error range by a predetermined number of times or more. Thus, setting the assessment period used for the determination to be longer or combining a plurality of patterns makes it possible to more accurately detect a malicious unauthorized use that is habitual or regular, while each unauthorized use is a small-scale one. For example, by setting a longer assessment period used for the determination, an unauthorized use can be detected with high accuracy even if a purchased fuel amount is divided and consumed, the fuel being supplied into a tank in a plurality of times, or a purchase timing and a start timing of the assessment period are widely separated from each other.

Further, the result output means 34 may output, at regular intervals, the list of the data used for determination and the determination result for each equipment 21 to be determined or for each station that includes the equipment 21 regardless of a determination result of unauthorized use. Listing and outputting the data makes it possible to use the data as an evidence if an unauthorized use is discovered.

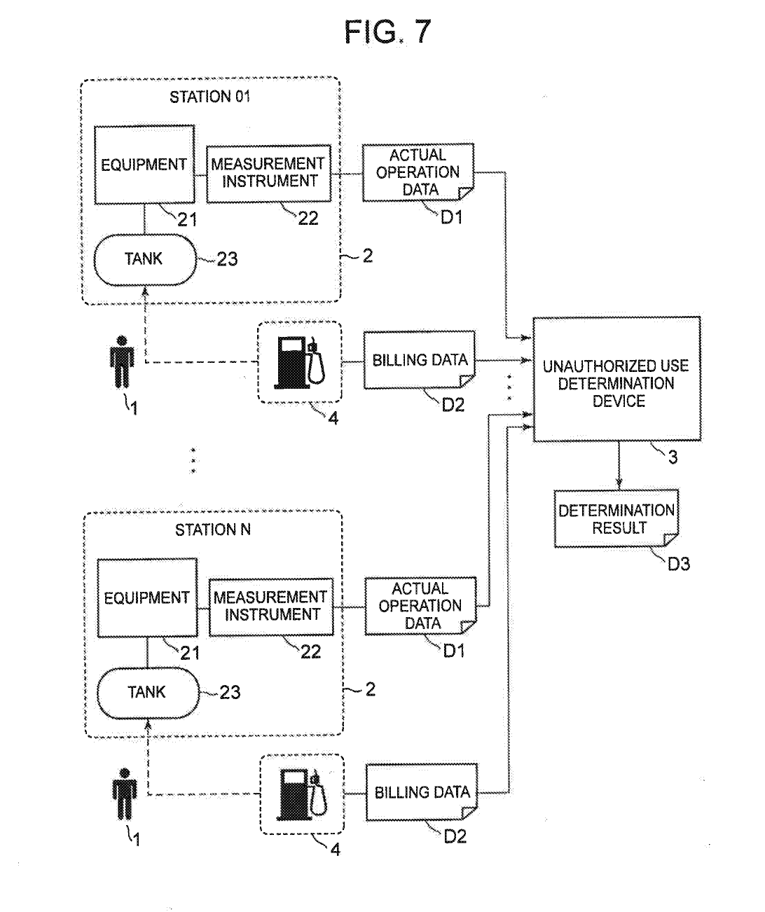

The unauthorized use determination device 3 may acquire the actual operation data D1 and the billing data D2 on two or more stations. FIG. 7 is a block diagram illustrating another example of the monitoring system according to the first embodiment. FIG. 7 illustrates an example of a monitoring system, in which the unauthorized use determination device 3 monitors for the unauthorized use of a fuel to be supplied to the equipment 21 placed at each of two or more stations. The unauthorized use determination device 3 is connected to the measurement instrument 22 connected to the equipment 21 installed at each station. In this case also, the unauthorized use determination device 3 may acquire the actual operation data D1 and the billing data D2 for each equipment 21 to determine an unauthorized use.

Further, in the case where the unauthorized use determination device 3 determines an unauthorized use on the equipment 21 at each of two or more stations, the determining means 33 may, for example, compare at least the consumption amount, the purchase amount or the difference therebetween among two or more pieces of equipment 21 considered to have similar or substantially the same operating conditions, and if the difference therebetween is a predetermined amount or more, then the determining means 33 may provide an output indicating the possibility of an unauthorized use. The examples of the equipment 21 considered to have similar or substantially the same operating conditions include one of or a combination of the following: the pieces of equipment are installed in areas near each other and share the same power supply system, are the same model or have the same age of service. As the examples of the comparison in the consumption amount and/or the purchase amount between two or more pieces of equipment 21 considered to have similar or substantially the same operating conditions, the fuel purchase amounts, the fuel consumption amounts, or the differences between the fuel purchase amount and consumption amount may be compared between equipment 21a and equipment 21b, which are considered to have similar or substantially the same operating conditions. In such a case, if a comparison result indicates that a difference is a predetermined threshold value or more, then the determining means 33 may determine that there has been an unauthorized use of the fuel to be supplied to one of the pieces of equipment 21. If there are three or more pieces of equipment 21 to be compared, then the determining means 33 may determine that there has been an unauthorized use of the fuel in the equipment 21 that indicates a largest variation with respect to an average.

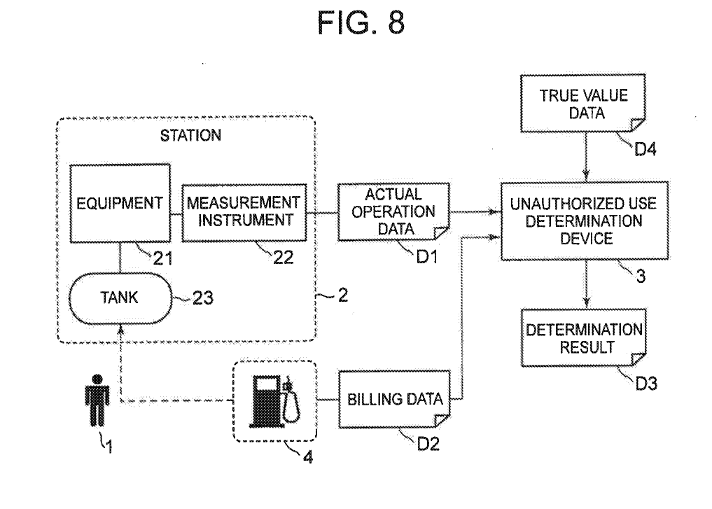

Further, FIG. 8 is a block diagram illustrating another example of the monitoring system according to the first embodiment. FIG. 8 illustrates an example of the monitoring system in which the unauthorized use determination device 3 further acquires, as true value data D4, the actual consumption amount (the consumption amount in a particular period) with respect to the actual output amount (the output amount measured per measurement time unit) of the equipment 21 or the equipment considered to have operating conditions that are similar to or substantially the same as those of equipment 21, the actual output amount having been measured in advance using a measuring instrument or a sensor or the like for detecting the amount remaining in a tank in a condition with no injustice. The true value data D4 may be stored in the unauthorized use determination device 3 in advance together with the information indicating the operating conditions at the time of measurement. In this case, the consumption amount calculating means 32 of the unauthorized use determination device 3 may use the pair of the output amount and the consumption amount indicated by the true value data D4 as teacher data to determine the consumption amount in the measurement period that corresponds to the output amount in each measurement period included in the assessment period indicated by the actual operation data D1. In other words, instead of selecting the fuel consumption rate based on the output amount in each measurement period, a net consumption amount determined on the basis of an actual environment of substantially the same condition may be used to determine the consumption amount in each measurement period.

### Second Embodiment

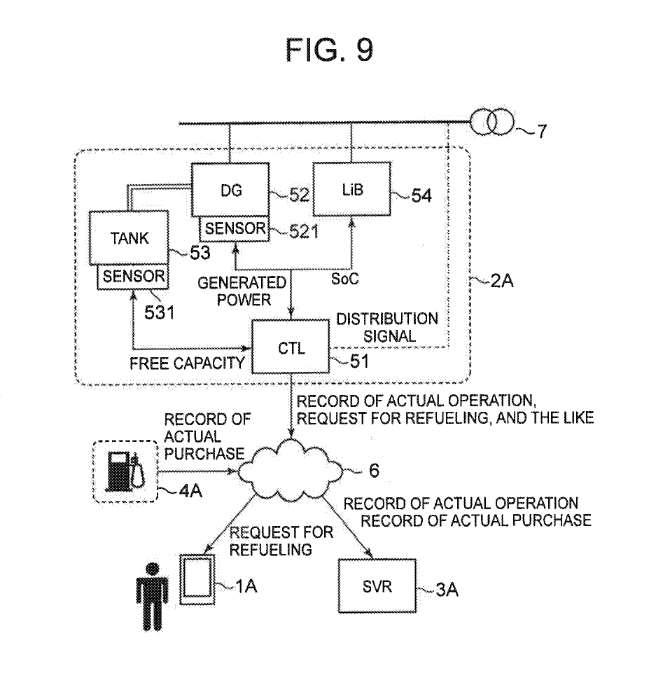

A description will now be given of a second embodiment with reference to the accompanying drawings. The second embodiment is a more specific example of the monitoring system of the first embodiment. FIG. 9 is a block diagram illustrating an example of the monitoring system of the second embodiment. The monitoring system illustrated in FIG. 9 includes a CTL 51, a DG 52, a sensor 521 attached to the DG 52, a tank 53, a sensor 531 attached to the tank 53, and a LiB 54, all of which are installed at a station 2A, and an SVR 3A and a superintendent terminal 1A, which are connected with the CTL 51 through a network 6.

The CTL 51 is a computer that operates as an energy management system (EMS) controller. Further, the DG 52 is a diesel generator corresponding to the equipment 21 in the first embodiment. Further, the sensor 521 is a sensor corresponding to the measurement instrument 22 in the first embodiment, and constantly monitors the amount of power generated by the DG 52. Further, the sensor 531 monitors the free capacity of the tank 53. Further, the LiB 54 is a lithium storage battery. Further, an SVR 3A corresponds to the unauthorized use determination device 3 in the first embodiment.

In the configuration described above, the CTL 51 is connected with the sensor 531, the sensor 521, and the LiB 54 within the station 2A and also connected with the SVR 3A and the superintendent terminal 1A through the network 6. The free capacity [L] of the tank 53 is input to the CTL 51 from the sensor 521. Further, the generated power amount [W] of the DG 52 is input to the CTL 51 from the sensor 521. Further, the state of charge ((SoC); the ratio of the amount of charged electricity with respect to the battery capacity, i.e. the electric capacity) is input to the CTL 51 from the LiB 54. Further, the CTL 51 monitors the electricity distribution signals sent from a system 7 of power supply to various types of communication devices or the like installed at the station 2A, and detects the ON/OFF of the power supply on the basis of the electricity distribution signals.

Further, the record of actual operation, including the amount of generated power per measurement time unit as the output amount based on the data output from the sensor 521, is input to the SVR 3A in the present embodiment through the intermediary of the CTL 51. Further, the purchase cost of a fuel purchased to be supplied to the tank 53 at the station 2A is input to the SVR 3A as the record of actual purchase from a gas station 4A. The record of actual purchase includes a date, the amount of a purchased fuel, and a purchase price. Further, the fuel consumption rate of the DG 52 is stored in the SVR 3A in advance.

In the configuration described above, the CTL 51 monitors the output (the amount of generated power) of the sensor 521, determines the amount of generated power per measurement time unit, and transmits the information, which includes the determined amount of generated power per measurement time unit, to the SVR 3A as the record of actual operation. The record of actual operation includes the information of measurement period, the amount of generated power, and the free capacity of the tank.

The SVR 3A retains the record of actual purchase and the record of actual operation, which have been received, as the histories, and determines the purchase amount and the consumption amount of the fuel of the DG 52 in a specified assessment period by referring to the foregoing histories at a predetermined timing. Then, the SVR 3A compares the purchased amount and the consumption amount, which have been determined, and determines the occurrence of an unauthorized use. Alternatively, the SVR 3A in the present embodiment may, for example, determine the amount (remaining amount) of the fuel remaining in the tank on the basis of the free capacity of the tank, and may output a message indicating a request for refueling to the superintendent terminal 1A if the remaining amount falls below a predetermined threshold value. At this time, the SVR 3A may determine the remaining time, which indicates how long the operation can be continued on the amount remaining in the tank on the basis of the remaining amount and the determined purchase amount or consumption amount of the fuel. The SVR 3A may include, for example, the remaining amount and the remaining time in the request for refueling.

Further, if it is detected that the power supply of the system 7 has been cut off, then the CTL 51 of the present embodiment may switch an output changeover switch, which is not illustrated, to the LiB 54 side so as to cause the LiB 54 to perform power supply (discharge) to the system 7 if the LiB 54 is sufficiently charged, e.g. the SoC is a predetermined threshold value or more. Meanwhile, if the LiB 54 is not sufficiently charged, e.g. the SoC is below a predetermined threshold value, then the CTL 51 may switch the output changeover switch to the DG 52 side so as to cause the DG 52 to perform power supply to the LiB 54 and the system 7.

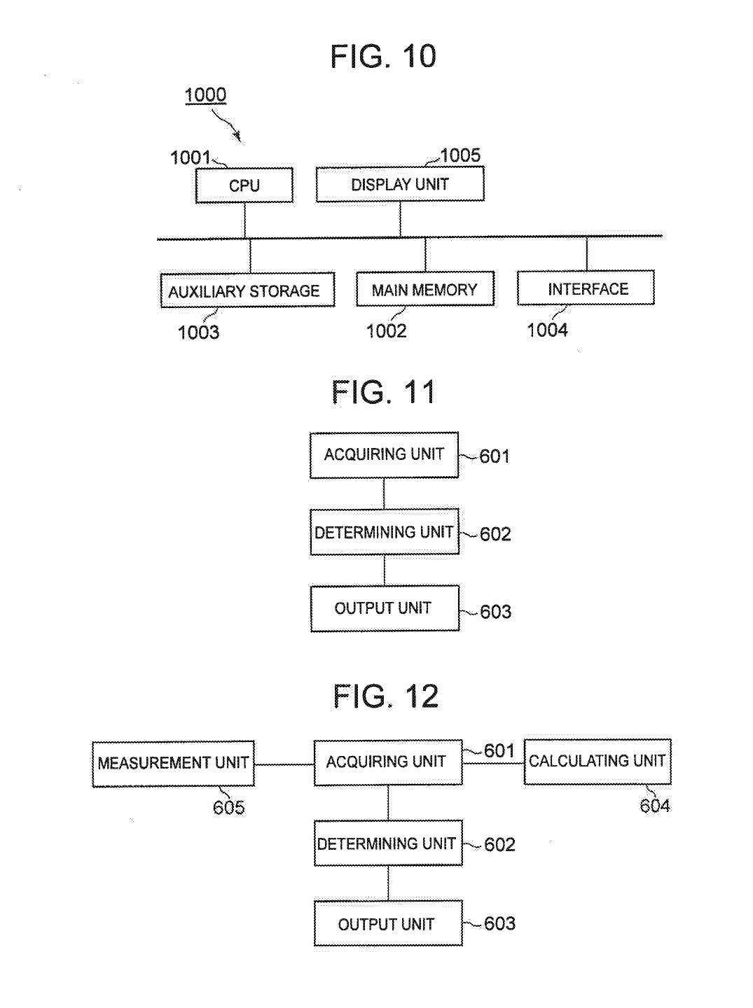

A description will now be given of a configuration example of the computer related to the embodiments of the present invention. FIG. 10 is a schematic block diagram illustrating a configuration example of a computer related to the embodiments of the present invention. A computer 1000 includes a CPU 1001, a main memory 1002, an auxiliary storage 1003, an interface 1004, and a display unit 1005.

The computer 1000 may be, for example, a computer operating as the unauthorized use determination device 3, the SVR 3A or the CTL 51 of the monitoring system described above. In such a case, the operations of the unauthorized use determination device 3, the SVR 3A or the CTL 51 or each processing unit therein may be stored in the form of a program in the auxiliary storage 1003. The CPU 1001 reads the program from the auxiliary storage 1003 and decompresses the program in the main memory 1002 to carry out predetermined processing in each embodiment according to the program.

The auxiliary storage 1003 is an example of a non-temporary tangible medium. Other examples of non-temporary tangible media include magnetic disks, magneto-optical disks, CD-ROMs, DVD-ROMs and semiconductor memories connected through the interface 1004. Further, in the case where the program is distributed to the computer 1000 through a communication line, the computer 1000 receiving the program may decompress the program in the main memory 1002 to carry out the predetermined processing in each embodiment.

The program may be adapted to implement a part of the predetermined processing in each embodiment. Further, the program may be a differential program for implementing the predetermined processing in each embodiment by being combined with another program already stored in the auxiliary storage 1003.

Further, depending on the processing contents in an embodiment, some elements of the computer 1000 can be omitted. For example, if the unauthorized use determination device 3 or the SVR 3A outputs determination results or the like to a server connected through a network, then the display unit 1005 can be omitted. Although not illustrated in FIG. 10, the computer 1000 may be provided with an input device, depending on the processing contents in an embodiment. The computer 1000 may, for example, prompt a user to enter a start trigger of monitoring processing through the input device.

Further, some or all of the constituent elements of each device are implemented by a general or dedicated circuitry, a processor, or a combination of the general or dedicated circuitry and the processor. These may be constituted by a single chip or a plurality of chips connected through a bus. Further, some or all of the constituent elements of each device may be implemented by a combination of the circuitry or the like and the program described above.

If some or all of the constituent elements of each device are implemented by a plurality of information processing devices, circuits or the like, then the plurality of information processing devices, circuitry or the like may be disposed in a centralized manner or disposed in a decentralized manner. For example, the information processing devices, circuitry or the like may be implemented in a form in which a client and server system, a cloud computing system and the like are individually connected through communication networks.

The monitoring system and an image processing device according to the present invention will now be outlined. FIG. 11 is a block diagram illustrating the outline of the monitoring system in accordance with the present invention. The monitoring system illustrated in FIG. 11 includes an acquiring unit 601, a determining unit 602, and an output unit 603.

The acquiring unit 601 (e.g. the data acquiring means 31) acquires actual operation data including a value indicating an output amount, which is an observable amount correlated to the fuel consumption of target equipment and which is an observable amount per measurement time unit in at least an assessment period, and billing data including a value indicating a purchase amount, which is the amount of a fuel purchased to be supplied to the target equipment during the assessment period.

The determining unit 602 (e.g. the determining means 33) determines the occurrence of an unauthorized use on the basis of the output amount per measurement time unit in the assessment period of the target equipment indicated by the actual operation data and the purchase amount of the fuel in the assessment period of the target equipment indicated by the billing data.

The output unit 603 (e.g. the result output means 34) outputs a determination result.

According to the configuration described above, the consumption amount of a fuel in an assessment period can be accurately determined, thus leading to higher accuracy in determining the occurrence of an unauthorized use. As a result, an unauthorized use of a fuel by a superintendent with a malicious intent can be monitored even in an environment in which a fuel is supplied to equipment by manpower.

FIG. 12 is a block diagram illustrating another example of the monitoring system in accordance with the present invention. As illustrated in FIG. 12, the monitoring system may be provided further with a calculating unit 604 and a measurement unit 605.

The calculating unit 604 (e.g. the consumption amount calculating means 32) may calculate the consumption amount of a fuel in an assessment period of target equipment on the basis of the output amount per measurement time unit in the assessment period of the target equipment indicated by the actual operation data, and one fuel consumption rate selected from among the fuel consumption rates prepared in advance which are associated with the output amounts per time unit of the target equipment and which are associated with the values of two or more output amounts.

Further, the calculating unit 604 may calculate the consumption amount of a fuel in the assessment period of the target equipment on the basis of the output amount per measurement time unit in the assessment period of the target equipment indicated by the actual operation data, and the actual fuel consumption amount with respect to an actual output amount per measurement time unit of the target equipment or equipment considered to have operating conditions similar to or substantially the same as those of the target equipment, the output amount being prepared in advance and having been measured under a condition with no injustice.

In the configuration that includes the calculating unit 604, the determining unit 602 may determine the occurrence of an unauthorized use by comparing the purchase amount of a fuel in the assessment period of the target equipment and the consumption amount of the fuel in the assessment period of the target equipment.

Further, the determining unit 602 may determine that there is an unauthorized use if the difference between the purchase amount and the consumption amount of a fuel in two or more different assessment periods continuously or cumulatively exceeds an error range by a predetermined number of times or more.

Further, the determining unit 602 may compare the purchase amount or the consumption amount of a fuel or the difference therebetween in an assessment period among equipment considered to have similar or the same operating conditions, thereby determining the occurrence of an unauthorized use of the fuel in any one of the pieces of equipment.

Further, the measurement unit 605 (e.g. the measurement instrument 22) is installed in or connected to the target equipment, and measures a value indicating an output amount, which is an observable amount correlated to the fuel consumption of the target equipment and which is an observable amount per measurement time unit in at least an assessment period.

The above has described the present invention with reference to the embodiments and the examples. However, the present invention is not limited to the embodiments and the examples described above. A variety of changes that are understandable to persons skilled in the art can be added to the configurations and the details of the present invention within the scope of the present invention.

### INDUSTRIAL APPLICABILITY

The present invention can be ideally applied to preventive measures in addition to the monitoring for the unauthorized use of a fuel to be supplied to equipment, a device, a vehicle, a vessel or the like that operates on the fuel.

### REFERENCE SIGNS LIST

1 Superintendent
1A Superintendent terminal
2, 2A Station
21 Equipment
22 Measurement instrument
19
23 Tank
3 Unauthorized use determination device
31 Data acquiring means
32 Consumption amount calculating means
33 Determining means
34 Result output means
3A SVR
4, 4A Gas station
51 CTL
52 DG
53 Tank
531, 521 Sensor
54 LiB
6 Network
7 System
1000 Computer
1001 CPU
1002 Main memory
1003 Auxiliary storage
1004 Interface
1005 Display unit
601 Acquiring unit
602 Determining unit
603 Output unit
604 Calculating unit
605 Measurement unit

1. A monitoring system comprising:
an acquiring unit which implemented at least by a hardware including a processor and which acquires actual operation data including a value indicative of an output amount, which is an observable amount correlated to the consumption of a fuel of target equipment and which is an observable amount per measurement time unit in at least an assessment period, and billing data including a value indicative of a purchase amount, which is the amount of a purchased fuel to be supplied to the target equipment during the assessment period;
a determining unit which implemented at least by the hardware and which determines the occurrence of an unauthorized use on the basis of the output amount per measurement time unit in the assessment period of the target equipment indicated by the actual operation data and the purchase amount of a fuel in the assessment period of the target equipment indicated by the billing data; and
an output unit which outputs a determination result.

2. The monitoring system according to claim 1, comprising:
a calculating unit which implemented at least by the hardware and which calculates the consumption amount of a fuel in the assessment period of the target equipment on the basis of an output amount per measurement time unit in an assessment period of the target equipment indicated by the actual operation data, and one fuel consumption rate selected from among fuel consumption rates prepared in advance which are associated with an output amount per time unit of the target equipment and which are associated with the values of two or more output amounts,
wherein the determining unit determines the occurrence of an unauthorized use by comparing the purchase amount of the fuel in the assessment period of the target equipment and the consumption amount of the fuel in the assessment period of the target equipment.

3. The monitoring system according to claim 1, comprising:
a calculating unit which implemented at least by the hardware and which calculates the consumption amount of a fuel in the assessment period of the target equipment on the basis of the output amount per measurement time unit in the assessment period of the target equipment indicated by the actual operation data, and an actual fuel consumption amount with respect to an actual output amount per measurement time unit of the target equipment or equipment considered to have operating conditions that are similar to or the same as those of the target equipment, the actual output amount being prepared in advance and having been measured in a condition with no injustice,
wherein the determining unit determines the occurrence of unauthorized use by comparing a fuel purchase amount in the assessment period of the target equipment and a fuel consumption amount in the assessment period of the target equipment.

4. The monitoring system according to claim 2,
wherein the determining unit determines that an unauthorized use has occurred in the case where a difference between a purchase amount and a consumption amount of a fuel in two or more different assessment periods continuously or cumulatively exceeds an error range by a predetermined number of times or more.

5. The monitoring system according to claim 2,
wherein the determining unit determines the occurrence of the unauthorized use of a fuel in one of pieces of equipment considered to have similar or the same operating conditions by comparing a purchase amount and a consumption amount of a fuel or the difference between the purchase amount and the consumption amount in an assessment period among the pieces of equipment.

6. The monitoring system according to claim 1, comprising:
a measurement unit which implemented at least by the hardware and which is installed in or connected to the target equipment, and which measures a value indicating an output amount, which is an observable amount correlated to the fuel consumption of the target equipment and which is an observable amount per measurement time unit in at least an assessment period.

7. The monitoring system according to claim 1,
wherein the target equipment is a generator, and the output amount is the amount of generated power.

8. An unauthorized use determination device, comprising:
an acquiring unit which implemented at least by a hardware including a processor and which acquires actual operation data including a value indicative of an output amount, which is an observable amount correlated to the consumption of a fuel of target equipment and which is an observable amount per measurement time unit in at least an assessment period, and billing data including a value indicative of a purchase amount, which is the amount of a purchased fuel to be supplied to the target equipment during the assessment period;
a determining unit which implemented at least by the hardware and which determines the occurrence of an unauthorized use on the basis of the output amount per measurement time unit in the assessment period of the target equipment indicated by the actual operation data and the purchase amount of a fuel in the assessment period of the target equipment indicated by the billing data; and
an output unit which implemented at least by the hardware and which outputs a determination result.

9. A monitoring method comprising:
by an information processing device, acquiring actual operation data including a value indicative of an output amount, which is an observable amount correlated to the consumption of a fuel of target equipment and which is an observable amount per measurement time unit in at least an assessment period, and billing data including a value indicative of a purchase amount, which is the amount of a purchased fuel to be supplied to the target equipment during the assessment period;
determining the occurrence of an unauthorized use on the basis of the output amount per measurement time unit in the assessment period of the target equipment indicated by the actual operation data and the purchase amount of a fuel in the assessment period of the target equipment indicated by the billing data; and
outputting a determination result.

10. (canceled)
